(19) United States
(12) Patent Application Publication
(10) Pub. No.: US 2019/0362075 A1
(43) Pub. Date: Nov. 28, 2019

(54) PREVENTING USERS FROM ACCESSING INFECTED FILES BY USING MULTIPLE FILE STORAGE REPOSITORIES AND A SECURE DATA TRANSFER AGENT LOGICALLY INTERPOSED THEREBETWEEN

(71) Applicant: Fortinet, Inc., Sunnyvale, CA (US)

(72) Inventor: Robert Kríz, Dubendorf (CH)

(73) Assignee: Fortinet, Inc., Sunnyvale, CA (US)

(21) Appl. No.: 15/985,892

(22) Filed: May 22, 2018

(51) Int. Cl. G06F 21/56; G06F 21/53; G06F 21/62; G06F 17/30

(52) U.S. Cl. CPC G06F 21/568; G06F 21/562; G06F 21/53; G06F 2221/2141; G06F 17/30203; G06F 17/30221; G06F 21/6218

(57) ABSTRACT

Systems and methods are provided for ensuring files that are newly introduced to a network or a defined portion thereof are first subjected to desired security checks, by a sandbox appliance, for example, while residing in a segregated data storage area before they are made available for access by copying only known good files to a sanitized storage area that is accessible to users. According to one embodiment, a determination is made by a network security device associated with the enterprise network regarding whether a file stored in a first repository contains malicious content by applying one or more security checks to the file. The users do not have read access to the first repository. When a result of the determination is negative, then the file is copied by the network security device from the first repository to a second repository that is accessible to the users.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2018, Fortinet, Inc.

### BACKGROUND

### Field

Embodiments of the present invention generally relate to network security. In particular, embodiments of the present invention relate to performing state of the art content and/or behavioral scanning of files by a sandbox appliance, for example, received from untrusted sources before they are securely transferred to a sanitized location accessible to internal users of an enterprise, thereby protecting users from various types of malware, including zero day threats.

### Description of the Related Art

Network security consists of policies and practices that are adopted to prevent and monitor unauthorized access, misuse, modification, or denial of a computer network or network-accessible resources. Network security also involves authorization of access to data in a network that is controlled by a network administrator. Computing devices that form part of a computer network, such as an enterprise network, are continually threatened by a risk of attack from various types of malicious content, including, but not limited to, viruses, malware, worms, and Trojans, while accessing data that has been transferred to internal locations from an external source and/or data that has been transferred between different departments, having different levels of trust, by various ways such as through servers, physical storage devices, among other communication channels. One exemplary source of malware infection includes data that is externally uploaded or is provided from untrusted, semi trusted servers that various users then have access to. Another source is the user himself/herself transmitting malware infected data to other users.

Although there are many virus scanning and content filtering systems that purport to protect users from malicious content, including anti-virus (AV) scanners on file systems or applications using the Internet Content Adaptation Protocol (ICAP) for file checking, such systems are reactive in nature. So, while these systems are capable of verifying data and may have the ability to take action to remove bad files once they are discovered, damage may already have been done. When an infected file is discovered by existing AV scanners and file checking systems, the threat is either reported afterwards (i.e., after access to such infected file has already been made available to one or more users) or the threat is reported during execution of such infected file, thereby risking exposure of the network and/or the computing devices in the network between the time the file is introduced until the file is finally inspected.

Therefore, there exists a need for a new paradigm according to which newly introduced files are physically segregated until they are properly scanned, thereby ensuring only known good files are made available for access to users.

### SUMMARY

Systems and methods are described for ensuring files that are newly introduced to a network or a defined portion thereof are first subjected to desired security checks while residing in a segregated data storage area before they are made available for access by copying only known good files to a sanitized storage area that is accessible to users. According to one embodiment, a determination is made by a network security device associated with the enterprise network regarding whether a file stored in a first repository contains malicious content by applying one or more security checks to the file. The users do not have read access to the first repository. When a result of the determination is negative, then the file is copied by the network security device from the first repository to a second repository that is accessible to the users.

Other features of embodiments of the present disclosure will be apparent from accompanying drawings and from detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A-C illustrate exemplary network architectures in which or with which embodiments of the present invention can be implemented.

FIG. 2 illustrates an exemplary module diagram for a secure file transfer agent in accordance with an embodiment of the present invention.

FIGS. 3A to 3C conceptually illustrate the segregation of newly introduced files from those known to be good in accordance with an embodiment of the present invention.

FIG. 4 is a sequence diagram illustrating file processing in accordance with an embodiment of the present invention.

FIG. 5 is a flow diagram illustrating a method of secure data transfer in accordance with an embodiment of the present invention.

FIG. 6 illustrates an exemplary computer system in which or with which embodiments of the present invention may be utilized.

### DETAILED DESCRIPTION

Systems and methods are described for ensuring only known good files are accessible by users. According to one embodiment, files that are newly introduced to a network or a defined portion thereof are first subjected to desired security checks (e.g., AV scanning, file checking, sandboxing, etc.) while residing in a segregated data storage area before they are made available for access to users by copying only those files passing the security checks to a sanitized storage area that is accessible to the users. In this manner, the typical model, involving the removal of bad files upon their identification, is turned on its head by initially storing untrusted files in a separate data location that is inaccessible to end users and then after the untrusted files have been verified as being free of malware (clean) by a secure data transfer system, the verified clean files are transferred to a data location that is accessible to end users.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

Systems and methods are described for ensuring files that are newly introduced to a network or a defined portion thereof are first subjected to desired security checks while residing in a segregated data storage area before they are made available for access by copying only known good files to a sanitized storage area that is accessible to users.

In an exemplary aspect, the present disclosure provides a secure data transfer system that includes: a non-transitory storage device having embodied therein one or more routines operable to prevent users (also interchangeably referred to as “end users”) of an enterprise network from accessing malware infected files; and one or more processors coupled to the non-transitory storage device and operable to execute the one or more routines, wherein the one or more routines can include: a file processing module, which when executed by the one or more processors: accesses an untrusted file stored within a first repository associated with the enterprise network, wherein the users do not have read access to the first repository; and determines the untrusted file is a clean file that is free of malware by applying one or more security checks to the untrusted file; and a clean file transfer module, which when executed by the one or more processors, makes the clean file accessible to the users by, when a result of the determining is affirmative, copying the clean file from the first repository to a second repository that is accessible to the users.

In an aspect, the secure data transfer system can include a network security device, wherein the network security device can include a sandbox appliance, and wherein the one or more security checks can include behavioral-based malware detection.

In an aspect, the file processing module can further remove any malware from the untrusted file that is detected by the one or more security checks when the result of the determining is negative.

In another aspect, the first repository and the second repository can be on different storage devices. In yet another aspect, the first repository and the second repository can be on a common storage device. In yet another aspect, the second repository can be part of the first repository and can be configured such that the one or more users, based on their authentication and/or access rights, are able to access only the second repository portion of the first repository.

In an aspect, the file can be received from a user computing device present in the enterprise network or a web server, where the network security device can copy/transfer the file to the second repository by sharing it by means of any or a combination of network file system (NFS), file transfer protocol (FTP), common Internet file system (CIFS), Internet Small Computer Systems Interface (iSCSI), Storage Area Network (SAN), and local storage.

In an aspect, the present disclosure further relates to a method for preventing users of an enterprise network from accessing malware infected files, where the proposed method can include the steps of: determining, by a network security device associated with the enterprise network, whether a file stored in a first repository contains malware by applying one or more security checks to the file, wherein the users do not have read access to the first repository; and when a result of the determining is negative, then transferring and/or copying, by the network security device, the file from the first repository to a second repository, wherein the second repository is accessible to the users.

Although the present disclosure has been described with the purpose of enabling users to access only clean/scanned/sanitized files, it should be appreciated that the same has been done merely to illustrate the invention in an exemplary manner and any other purpose or function for which the explained structure or configuration can be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

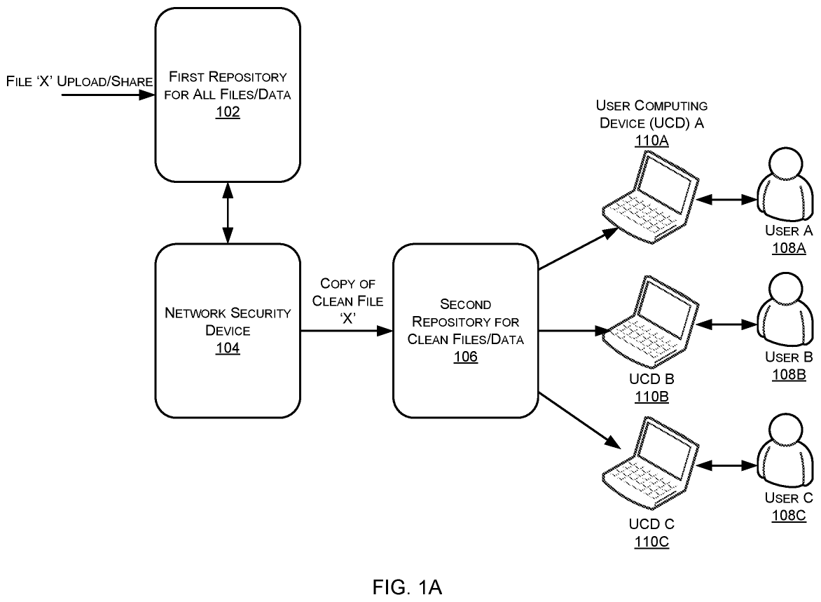

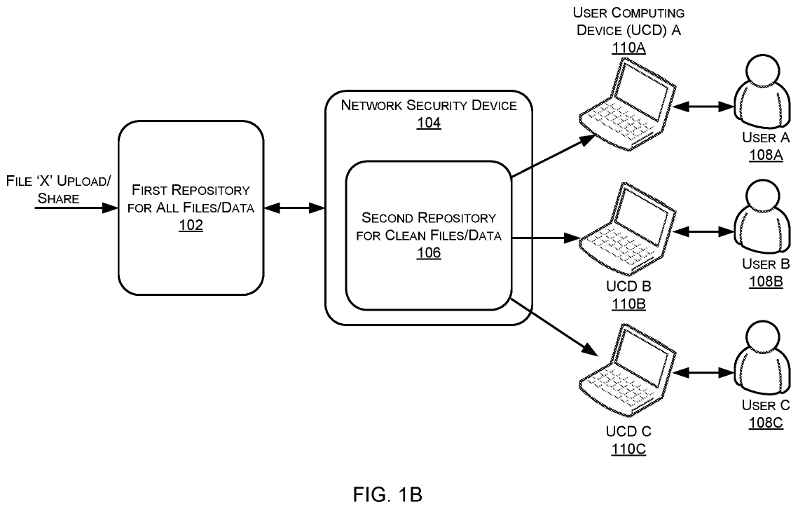

FIGS. 1A-C illustrate exemplary network architectures in which or with which embodiments of the present invention can be implemented.

FIG. 1A illustrates an exemplary network architecture in which a file is received from an external network/web server for use in a network (for instance, an enterprise network) operatively configured with a secure data transfer system in accordance with an embodiment of the present invention.

In the context of the present example, a file ‘X’ (which may be interchangeably referred to herein as an untrusted file initially) can be sent by an external entity to a user (e.g., user A 108A via his his/her user computing device UCD A 110A, user B 108B via his/her user computing device UCD B 110B or user C 108C via his/her user computing device UCD C 110C). Those skilled in the art will recognize there are many scenarios in which untrusted files can be introduced into an enterprise network. For example, file ‘X’ might represent an attachment to an electronic mail message (e-mail) addressed to user A. Alternatively, files may be uploaded from external sources through a web form of a web server of the enterprise. Users of the network are typically free to initiate actions to access external content. As such, using the Internet, user B 108B can visit a website and attempt to download a file from a music site, for instance. File ‘X’ might also represent a file obtained by the user from a cloud service. In other exemplary embodiments, file ‘X’ may be shared with a user in the enterprise network by an external entity or even a department within the same enterprise network may be attempting to share/send a file to another department. Embodiments of the present invention can be employed in any or all of these circumstances as elaborated further below.

In the context of the present example, the proposed secure data transfer system can be represented in the form of a network security device (NSD) 104, that is operable to perform security scanning on untrusted files, such as file ‘X,’ that are initially shared/sent/uploaded to a first repository 102 within the enterprise network before it is made accessible to its intended user/any user. First repository 102 can be configured to be inaccessible to enterprise network users (e.g., User A, User B, and User C).

When the security scanning indicates file ‘X’ is free of malware (clean), NSD 104 can transfer file ‘X’ from first repository 102 to a second repository 106, which is accessible to enterprise network users. In an aspect, NSD 104 of the present disclosure can include any or a combination of Unified Threat Management (UTM) appliance, a sandbox, a firewall, a content scanning engine, an anti-virus engine and a gateway device. User computing devices 110A-C can include, but are not limited to, a tablet computer, a laptop computer, a desktop computer, a smartphone, a wearable device among other like devices.

In one embodiment, NSD 104 is alerted to the existence of new files received within first repository 102 and processes the new files as they arrive. In another embodiment, NSD 104 may periodically check for the existence of new files within first repository 102 and process the new files in a batch. In one embodiment, the security checks applied by NSD 104 can include behavioral-based malware detection by executing the untrusted file within a sandbox environment to observe whether execution of the untrusted file reveals behavior indicative of the existence of malware.

As noted above, upon determining that the file at issue is clean, that is, free from malware, NSD 104 can make the clean file accessible to the users by copying and/or transferring the clean file from first repository 102 to second repository 106 that is accessible to the users.

In an aspect, second repository 106 can contain only clean files and such files may be available to various users as per their respective sharing rights etc. granted to them. For example, users of different departments may be limited to accessing file shares associated with their respective departments. At the same time, each user can have access to files created by him/her (after they have been verified as being clean) in this manner, making embodiments of the present invention very responsive and helpful in connection with avoidance of zero-day attacks. In this manner, embodiments of the present invention ensure that files that are newly introduced to a network or a defined portion thereof are first subjected to desired security checks while residing in a segregated data storage area before they are made available for access by copying only known good files to a sanitized storage area that is accessible to users.

In another aspect, either first repository 102 or second repository 106 can be represented by local storage within NSD 104 itself. A simplified architecture illustrating the latter is illustrated in FIG. 1B. A simplified architecture illustrating the former is illustrated in FIG. 1C. For instance, a storage area network (SAN) can be divided into two areas: one configured as first repository 102 and another as second repository 106. Clean files can be stored in first repository 106 as described above and access to them for different users can be granted, for example, on basis of authentication/access rights granted to each user that can be matched as appropriate by permissions associated with any file.

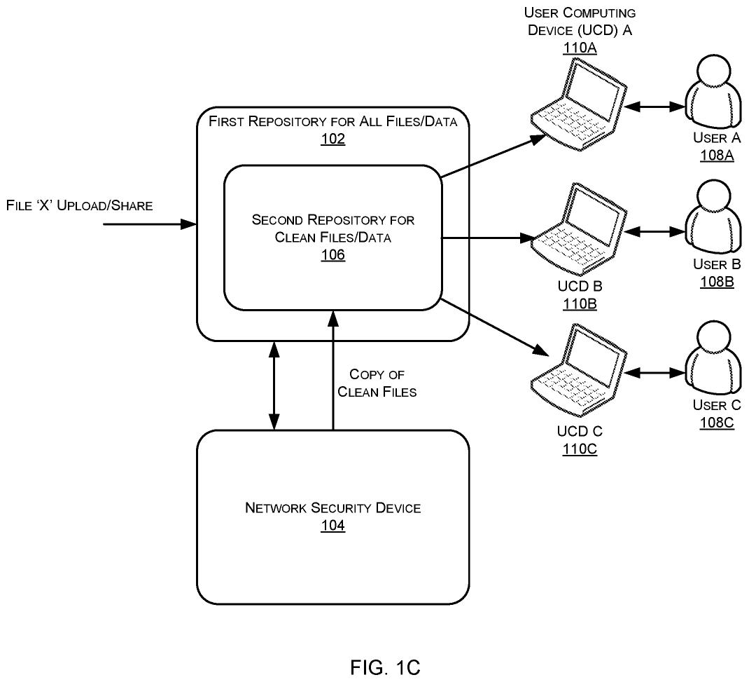

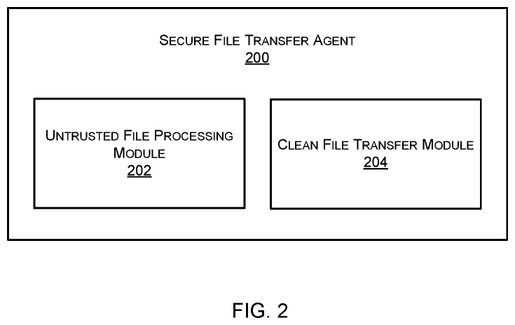

FIG. 2 illustrates an exemplary module diagram for a secure file transfer agent 200 in accordance with an embodiment of the present invention. In an aspect, the modules as described herein can be configured to be operatively connected to a website, or be part of a mobile application that can be downloaded on a mobile device that can connect to Internet, such mobile device being used in the manner of user computing devices (UCD) as described in connection with FIG. 1A. In such fashion, embodiments of the present invention can be available 24×7 to its users. Any other manner of implementation of the embodiments of the present invention or a part thereof is well within the scope of the present disclosure/invention.

In an aspect, the present disclosure can be configured as a secure file transfer agent 200 (as illustrated in FIG. 2) that can have an untrusted file processing module 202 and a clean file transfer module 204. In an aspect, module 202 can access an untrusted file stored within a first repository associated with the enterprise network, wherein the users do not have read access to the first repository. The untrusted file can be, for instance, one that has just been introduced to the network/file share system in which an embodiment of the present invention has been deployed, and is yet to be scanned for existence of potential malicious content.

In an aspect, module 202 can determine whether the untrusted file is a clean file that is free of malware by applying one or more security checks to the untrusted file, wherein the one or more security checks applied by module 202 can include, but are not limited to, state of the art content scanning and/or behavioral-based malware detection. In one embodiment, file processing module 202 can further remove any malware from the untrusted file that is detected by the one or more security checks when the result of the determination of the untrusted file being clean is negative (i.e., when the file demonstrates behavior indicative of the existence of malware or otherwise contains malicious content).

In an aspect, clean file transfer module 204 can make the clean file (confirmed or generated by module 202) accessible to the users by, when the result of determination of the untrusted file being clean is affirmative, copying or transferring the clean file from a first repository (e.g., first repository 102) that is inaccessible to end users to a second repository (e.g., second repository 106) that is accessible to end users. As can be readily understood, a clean file can be an untrusted file that has been found to be free of malware by module 202 or made free of malware/undesired attributes/behavior.

In an aspect, the proposed secure data transfer system can be configured as a network security device or be part of one, wherein the network security device can further include a sandbox appliance, such as one of the FORTISANDBOX family of sandbox appliances available from Fortinet, Inc., the assignee of the present invention. FORTISANDBOX is a trademark or registered trademark of Fortinet, Inc. of Sunnyvale, Calif.

In an exemplary embodiment, the first repository and the second repository can be on different storage devices, while in another exemplary embodiment, the first repository and the second repository can be on a common storage device, as elaborated further below. The first and second repositories may also be accessed via different file system access protocols. For example, a data store to which a webserver stores completed web forms may be mounted by the network security device as NFS and resulting clean files may be copied to file shares accessible to end users via CIFS. Any other potential implementation of how first and second repositories are configured are well within the scope of the present disclosure.

In an aspect, the untrusted file (on which threat detection and/or scanning is to be performed and eventually copied to second/safe repository) can be received from a user computing device present in the enterprise network or from a web server associated with the enterprise network.

In another aspect, the network security device can copy the file to the second repository by sharing it by means of any or a combination of network file system (NFS) file transfer protocol (FTP), common Internet file system (CIFS), Internet Small Computer Systems Interface (iSCSI), Storage Area Network (SAN), and local storage.

In yet another aspect, the second repository can be part of the first repository and can be configured such that the one or more users, based on their authentication and/or access rights, are able to access only the second repository portion of the first repository.

Those skilled in the art will appreciated that these are only exemplary modules and any other modules or sub-module can be included as part of embodiments of the present invention. These modules can also be merged or divided into super-modules or further sub-modules as appropriate for a particular implementation.

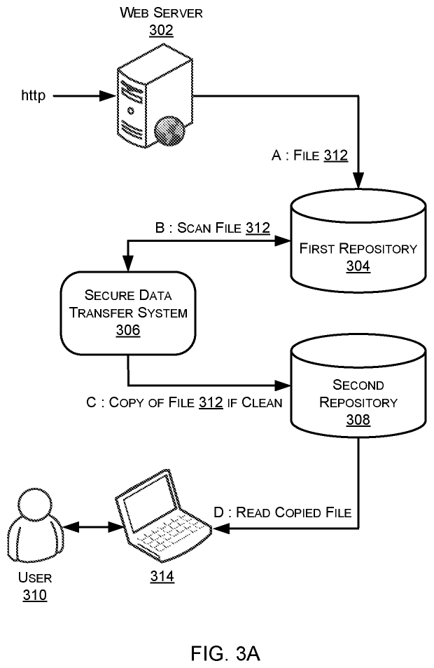

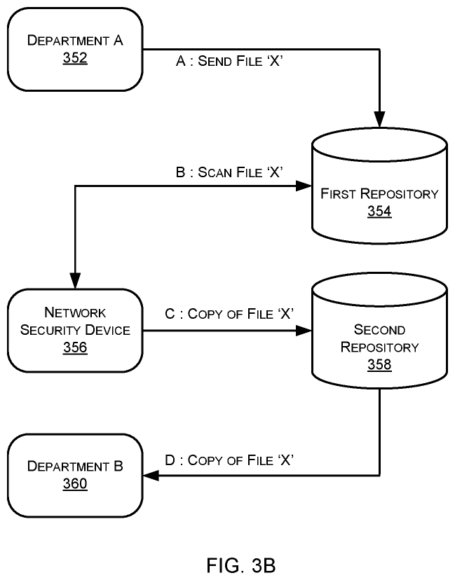

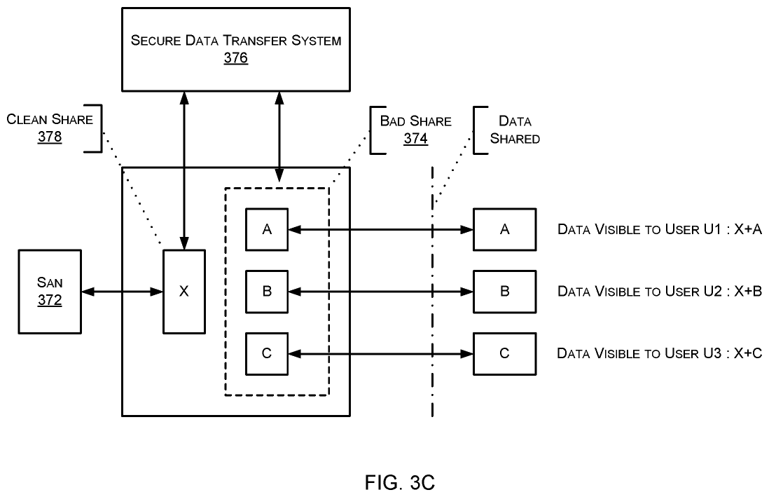

FIG. 3A conceptually illustrates the segregation of newly introduced files from those known to be clean in accordance with an embodiment of the present invention. The present example illustrates an exemplary implementation of a secure data transfer system 306 in which files from the Internet and/or a network external to the enterprise network being protected by secure data transfer system 306 are initially stored in a first repository 304 to which end users, such as user 310, do not have read access. The present example illustrates a scenario in which the role of certain users (e.g., customer support/service personnel, order fulfillment personnel, or the like) is to review and/or process files representing data submitted by external entities via a web server 302 by way of form submission and/or upload functionality provided by web server 302. In this context, it is desirable to segregate the files received from the external sources until they have been confirmed to be free of malicious content.

As illustrated, at step A, a file 312, which has been uploaded to web server 302 associated with the enterprise network by an external entity via a file upload form, for example, is initially stored in a first repository 304 that is inaccessible to (or at least not readable by) user 310. At step B, before file 312 is made accessible to user 310, secure data transfer system 306, which is logically or physically interposed between first repository 304 and a second repository 308, determines whether file 312 is a clean file that is free of malware by performing one or more configured security checks (e.g., AV scanning and/or behavior-based malware detection) on file 312. Upon determining file 312 is free of malware, i.e., clean, at step C, secure data transfer system 306 copies or transfers file 312 from first repository 304 to second repository 308 that is accessible to user 310 and/or other users. User 310 can then access and read file 312 via his/her computing device 314, as illustrated at step D.

FIG. 3B conceptually illustrates how sharing/exchange of files between two departments of an enterprise is handled in accordance with an embodiment of the present invention. In the context of the present example, a file (e.g., file ‘X’) may need to be made available by a first department within an enterprise (e.g., department A 352) that has a lower level of trust than a second department within the enterprise (e.g., department B 360). The present example illustrates a scenario in which a first department that implements less stringent security scanning of electronic data shares electronic data with a second department that requires more stringent security scanning of electronic data. In such a scenario, it is desirable to temporarily segregate files being transferred from the first department to the second department until they have been confirmed by the more stringent security scanning required of the recipient department to be free of malicious content.

As illustrated, at step A, file ‘X’ may be stored by a user associated with department A 352 to a first repository 354. First repository 354 may represent an intermediate file share, containing files that are to be made accessible to users of department B 360, which is inaccessible to (or at least not readable by) users associated with department B 360. At step B, before file ‘X’ is made accessible to users of department B 360, a secure data transfer system in the form of a network security device 356, which is logically or physically interposed between first repository 354 and a second repository 358, determines whether file ‘X’ is a clean file (in accordance with security policies applicable to department B 360) that is free of malware by performing one or more configured security checks (e.g., AV scanning and/or behavior-based malware detection) on file ‘X’. Upon determining file ‘X’ is free of malware, i.e., clean, at step C, network security device 356 copies or transfers file ‘X’ from first repository 354 to second repository 358 that is accessible to the users of department B 360. Second repository 358 may represent a dedicated file share for files that have been transferred from department A 352 to department B 360. Alternatively, second repository 308 may represent a file share containing all files available for viewing/access by users of department B 360. In any event, at this point, a user of department B 360 may access and read file ‘X’ via his/her computing device, as illustrated at step D.

FIG. 3C conceptually illustrates how sharing/exchange of files among enterprise users is handled in accordance with an embodiment of the present invention. In the context of the present example, a secure data transfer system 376 facilitates sharing of clean files among users (e.g., U1, U2 and U3) of an enterprise network. A storage area network 372 can provide dedicated individual file shares, visible only to their respective users (U1, U2 and U3) and illustrated as A, B, C within bad share 374, as well as a clean share 378, having one or more files represented as ‘X’ that are visible to all or a subset of users within a department, all or a subset of users assigned to a particular user group or all or a subset of users enterprise-wide, for example. In this manner, a user can download, create and/or modify files in his/her dedicated area and all files therein whether clean or malware infected can be accessible/viewable to the that user. For instance, a user U1 can be provided with an individual file share A in which user U1 can store all his/her files, and such files are always available to user U1 (after they have been confirmed as clean). Similarly, user U2 can be provided with an individual file share B and user U3 can be provided with an individual file share C.

According to one embodiment, read and write operations performed by the file system are directed to separate parallel directory structures within different file shares. For example, a write operation to the file system causes the file at issue to be placed within a particular directory within the directory structure within a quarantine area (e.g., bad share 374) that is physically or logically separate from a corresponding directory structure within a sanitized area (e.g., clean share 378) in which the file is copied/transferred after appropriate scanning has been performed and the file has been confirmed to be clean. During the scanning process, users having appropriate access rights to that portion of the directory structure within the sanitized area can see the file, but cannot open the file until it has been copied/transferred by secure data transfer system 376 to the sanitized area. For example, the file may be locked and presented as greyed out within the operating system's graphical user interface until the scanning and transfer to the sanitized area has been completed.

In the aggregate, data in all individual file shares A, B and C are considered a bad share 374 as it may possibly contain some files containing malicious content. However, in one embodiment, as files are introduced to or modified within the individual file shares A, B and C, secure data transfer system 376 may be triggered to employ the clean file share functionality described above to copy only clean files to clean share 378. For example, a sharing daemon (not shown) providing those shares (e.g., NFS, CIFS, etc.) may be triggered responsive to a file system write operation to activate scanning by secure data transfer system 376. Clean share 378 can be accessible to all the users or individual users, depending upon their respective access permissions, with the sharing daemon providing different views to each user. For instance, user U1 can view (but, not access) all his/her files (i.e., those stored in file share A, which are not scanned yet) as well as files in clean share 378, wherein X for him/her can represent files shared by one or more other users (e.g., U2) that are clean—assuming X grants access to U1 and U2 based on user group rights. Similarly, user U2 can view (but, not access) all his/her files (i.e., those stored in file share B, which are not scanned yet) as well as files in clean share 378, wherein X for him/her can constitute those files shared by one or more other users (e.g., U1) that are clean. And likewise, for user U3, he/she can view (but, not access) all files stored in file share C as well as files in clean share 378 to which he/she is granted appropriate access rights, wherein X for him/her can constitute those files shared by other users in his/her group that are clean. So, for example, when user U3 writes a file, it is first stored in share C and visible to him/her while the file is being scanned. Then, once the file has been confirmed to be clean, it is copied by secure data transfer system 376 to X, but may not be accessible to users U1 and U2 if this part of the directory structure does not grant read permissions to user U1 and U2. In this manner, the sharing daemon (e.g., NFS, CIFS, etc.) has a per user bad share where files are written responsive to write commands that trigger secure data transfer system 376 to scan the files and copy or transfer over those found to be clean to a sanitized location (e.g., clean share 378). As noted above, while a file is being scanned it can be locked until the scanning is complete. Once the file has been confirmed to be clean and has been transferred to the sanitized location, the file access permissions can be set back to those originally granted by the file system. Therefore, every user can see all clean files of other users (based on user group permissions) as well as those created within or downloaded to their respective individual file shares.

In one embodiment, as soon as a file is saved to a user's individual file share, for instance, when user U1 downloads a file, this new data is visible (but not yet accessible) to him/her. Once this new file is verified as being clean by secure data transfer system 376, it is copied over to clean share 378, thereby making it available to the originating user as well as other users associated with the originating user's user group as well. However, if the file is not clean, it will not be copied over to clean share 378, and hence the originating user is protected against malware, such as zero day attacks, and the spread of malware from one user to another is also effectively prevented by containing malware within the individual file share in which it was first introduced until it is properly scanned.

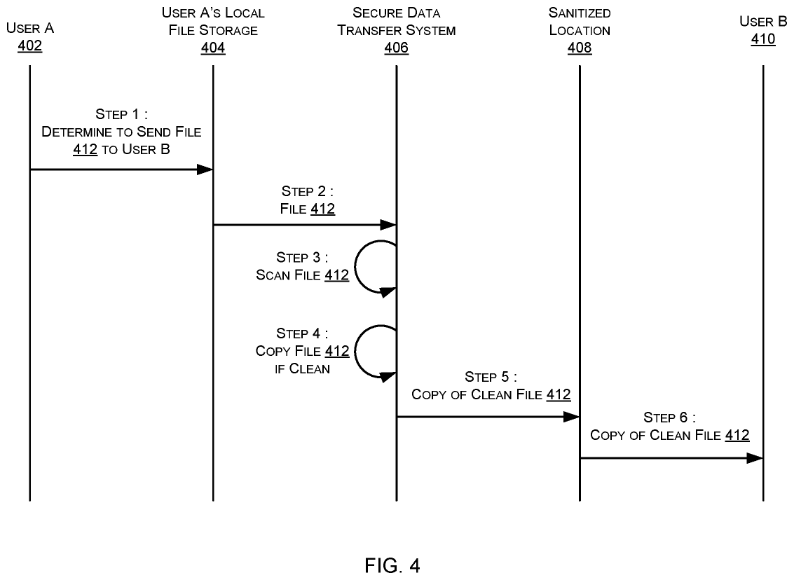

FIG. 4 is a sequence diagram illustrating file processing in accordance with an embodiment of the present invention. In the context of the present example, it is assumed a storage area network (e.g., storage area network 372 of FIG. 3C) provides dedicated individual file shares the contents of which are to be made visible and accessible to other users as described with reference to FIG. 3C.

As illustrated in FIG. 4, at step 1, a user A 402 initiates sharing of a file 412 with user B 410 (and potentially others) by simply storing or creating file 412 within user A's local storage 404 (which is designated for sharing with others in the enterprise within user A's user group), but which is not accessible to user B 410 or others. At step 2, secure data transfer system 406, upon detecting or being informed of the existence of file 412, reads file 412 and at step 3, scans file 412 in accordance with appropriate enterprise security policies. At step 4, responsive to a determination that file 412 is free of malicious content based on the security scanning performed by secure data transfer system 406, secure data transfer system 406 transfers file 412 from user A's local file storage 404 to a sanitized location 408 (e.g., clean share 378 of FIG. 3C) that is accessible to user B 410, as illustrated at step 5. If the security scanning performed by secure data transfer system 406 results in a determination that file 412 contains malicious content, file 412 is not transferred to sanitized location 408 and a notification regarding the findings may be provided to an administrator of the network and/or to user A 402. At step 6, user B 410 can access file 412 from sanitized location 408.

In an alternative embodiment, in which files stored into a user's dedicated file share is not automatically scanned and made available to other designated users, an additional intermediate file share (not shown) may be provided into which a copy of files to be shared are stored. In such an implementation, at step 1, user A 402 may initiate sharing of file 412 with user B 410 by storing a copy of file 412 (currently residing in user A's local storage 404) to the intermediate file share, representing a segregated storage area not accessible to user B 410 and in which files are held until they have been security scanned. At step 2, secure data transfer system 406, upon detecting or being informed of the existence of file 412, reads file 412 from the intermediate file share and at step 3, scans file 412 in accordance with appropriate security policies associated with the department, group or user(s) to which the file is being shared. At step 4, responsive to a determination that file 412 is free of malicious content based on the security scanning performed by secure data transfer system 406, secure data transfer system 406 transfers file 412 from the intermediate storage location to a sanitized location 408 that is accessible to user B 410, as illustrated at step 5. If the security scanning performed by secure data transfer system 406 results in a determination that file 412 contains malicious content, file 412 is not transferred to sanitized location 408 and a notification regarding the findings may be provided to an administrator of the network and/or to user A 402. At step 6, user B 410 can access file 412 from sanitized location.

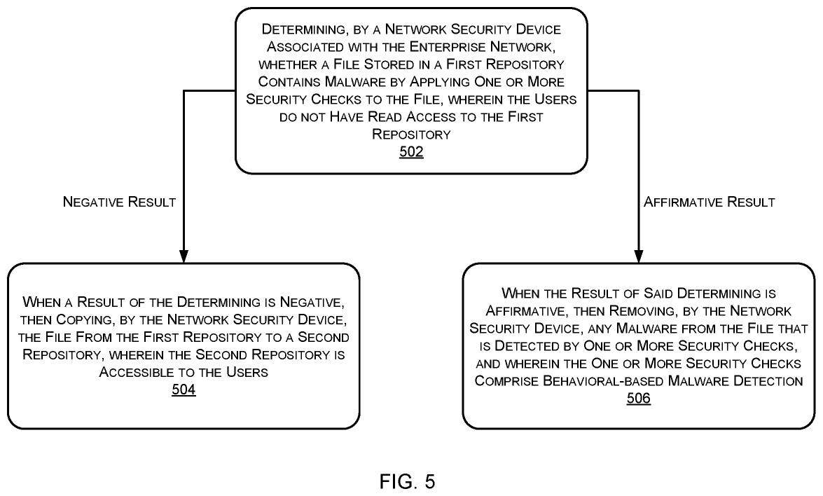

FIG. 5 is a flow diagram illustrating a method of secure data transfer in accordance with an embodiment of the present invention. In the context of the present example, the method begins, at block 502, by determining, by a network security device associated with the enterprise network, whether a file stored in a first repository contains malware by applying one or more security checks to the file, wherein the users to which the file is to be shared do not have read access to the first repository. At block 504, when a result of the determining of block 502 is negative (i.e., the file is determined to be free of malicious content), then copying, by the network security device, the file from the first repository to a second repository that is accessible to the users. At block 506, when the result of the determining is affirmative (i.e., the file is determined to contain malicious content), then removing, by the network security device, any malware from the file that is detected by one or more security checks, and wherein the one or more security checks comprise behavioral-based malware detection. Alternatively, rather than attempting to clean the file, a network administrator and/or the user initiating the sharing of the file can be alerted regarding the potential malicious nature of the file and the file can be quarantined for subsequent analysis.

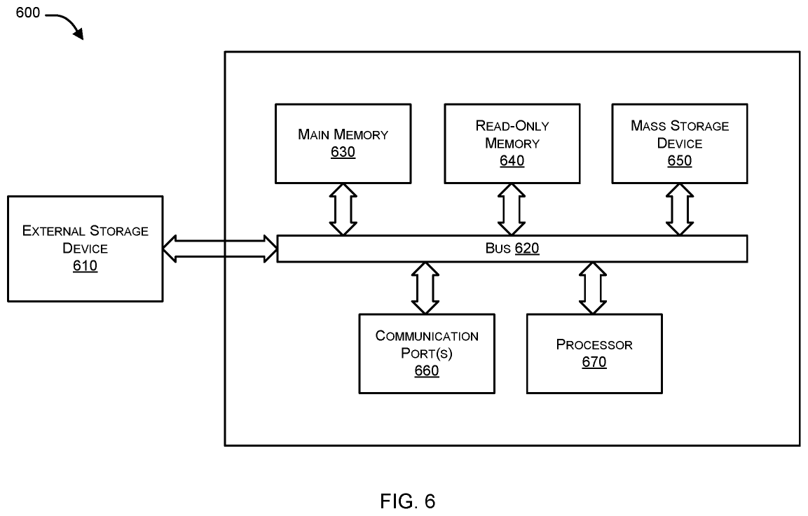

FIG. 6 illustrates an exemplary computer system 600 in which or with which embodiments of the present invention may be utilized. Computer system 600 may represent a secure file transfer agent (e.g., secure file transfer agent 200, secure data transfer system 306, secure data transfer system 376 or secure data transfer system 406) or a network security device (e.g., network security device 104 or network security device 356).

Embodiments of the present disclosure include various steps, which have been described above. A variety of these steps may be performed by hardware components or may be embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown in the figure, computer system 600 includes an external storage device 610, a bus 620, a main memory 630, a read only memory 640, a mass storage device 650, communication port 660, and a processor 670. A person skilled in the art will appreciate that computer system 600 may include more than one processor and communication ports. Examples of processor 670 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 670 may include various modules associated with embodiments of the present invention.

Communication port 660 can be any of an RS-232 port for use with a modem based dialup connection, a 10/100 Ethernet port, a Gigabit or 10 Gigabit port using copper or fiber, a serial port, a parallel port, or other existing or future ports. Communication port 660 may be chosen depending on a network, such a Local Area Network (LAN), Wide Area Network (WAN), or any network to which computer system 600 connects.

Memory 630 can be Random Access Memory (RAM), or any other dynamic storage device commonly known in the art. Read only memory 640 can be any static storage device(s) e.g., but not limited to, a Programmable Read Only Memory (PROM) chips for storing static information e.g., start-up or BIOS instructions for processor 670. SANs and VSANs may also be deployed.

Mass storage 650 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc. Bus 620 communicatively couples processor(s) 670 with the other memory, storage and communication blocks. Bus 620 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 670 to software system.

Optionally, operator and administrative interfaces, e.g., a display, keyboard, and a cursor control device, may also be coupled to bus 620 to support direct operator interaction with computer system 600. Other operator and administrative interfaces can be provided through network connections connected through communication port 660.

External storage device 610 can be any kind of external hard-drives, floppy drives, IOMEGA® Zip Drives, Compact Disc—Read Only Memory (CD-ROM), Compact Disc—-Re-Writable (CD-RW), Digital Video Disk—Read Only Memory (DVD-ROM). Components described above are meant only to exemplify various possibilities. In no way should the aforementioned exemplary computer system limit the scope of the present disclosure.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A secure data transfer system comprising:
a non-transitory storage device having embodied therein one or more routines operable to prevent users of an enterprise network from accessing malware infected files; and
one or more processors coupled to the non-transitory storage device and operable to execute the one or more routines, wherein the one or more routines include:
a file processing module, which when executed by the one or more processors:
accesses an untrusted file stored within a first repository associated with the enterprise network, wherein the users do not have read access to the first repository; and
determines whether the untrusted file is a clean file that is free of malicious content by applying one or more security checks to the untrusted file; and
a clean file transfer module, which when executed by the one or more processors, makes the clean file accessible to the users by, when a result of said determining is affirmative, copying the clean file from the first repository to a second repository that is accessible to the users.

2. The secure data transfer system of claim 1, wherein the secure data transfer system comprises a network security device.

3. The secure data transfer system of claim 2, wherein the network security device comprises a sandbox appliance and wherein the one or more security checks comprise behavioral-based malware detection.

4. The system of claim 2, wherein the network security device copies the file to the second repository by sharing it by means of any or a combination of network file system (NFS), file transfer protocol (FTP), common Internet file system (CIFS), Internet Small Computer Systems Interface (iSCSI), Storage Area Network (SAN), and local storage.

5. The secure data transfer system of claim 1, wherein the file processing module further removes any malware from the untrusted file that is detected by the one or more security checks when the result of said determining is negative.

6. The system of claim 1, wherein the first repository and the second repository are associated with different storage devices.

7. The system of claim 1, wherein the first repository and the second repository are associated with a common storage device.

8. The system of claim 1, wherein the file is received from a user computing device present in the enterprise network or a web server associated with the enterprise network.

9. The system of claim 1, wherein the second repository is part of the first repository and is configured such that the one or more users, based on their respective access rights, are able to access only the second repository portion of the first repository.

10. A method to prevent users of an enterprise network from accessing malware infected files, the method comprising:
determining, by a network security device associated with the enterprise network, whether a file stored in a first repository contains malicious content by applying one or more security checks to the file, wherein the users do not have read access to the first repository; and
when a result of said determining is negative, then copying, by the network security device, the file from the first repository to a second repository, wherein the second repository is accessible to the users.

11. The method of claim 10, wherein the network security device comprise a sandbox device and wherein the one or more security checks comprise behavioral-based malware detection.

12. The method of claim 10, further comprising when the result of said determining is affirmative, then removing, by the network security device, any malware from the file that is detected by the one or more security checks.

13. The method of claim 10, wherein the first repository and the second repository are on different storage devices.

14. The method of claim 10, wherein the first repository and the second repository are on a common storage device.

15. The method of claim 10, wherein the file is received from a user computing device present in the enterprise network or a web server.

16. The method of claim 10, wherein the network security device transfers the file to the second repository by sharing it by means of any or a combination of network file system (NFS), file transfer protocol (FTP), common Internet file system (CIFS), Internet Small Computer Systems Interface (iSCSI), Storage Area Network (SAN), and local storage.

17. The method of claim 10, wherein the second repository is part of the first repository and is configured such that the one or more users, based on their authentication and/or access rights, are able to access only the second repository portion of the first repository.
